(19) United States
(12) Patent Application Publication
(10) Pub. No.: US 2016/0032111 A1
(43) Pub. Date: Feb. 4, 2016

(54) Anticorrosive Layer Having a Biomimetic Leaf Surface Nano-microstructure And Application Thereof

(71) Applicant: CHUNG YUAN CHRISTIAN UNIVERSITY, Tao-Yuan County (TW)

(72) Inventors: Jui-Ming Yeh, Tao-Yuan County (TW); Kung-Chin Chang, Tao-Yuan County (TW); Chien-Hua Hsu, Tao-Yuan County (TW); Wei-Fu Ji, Tao-Yuan County (TW); Min-Hsiang Hsu, Tao-Yuan County (TW); Hsin-I Lu, Tao-Yuan County (TW); Mei-Chun Lai, Tao-Yuan County (TW); Pei-Ju Liu, Tao-Yuan County (TW); Tsao-Li Chuang, Tao-Yuan County (TW); Yen Wei, Tao-Yuan County (TW); Wei-Ren Liu, Tao-Yuan County (TW); You-Rong Hsiao, Tao-Yuan County (TW)

(21) Appl. No.: 14/475,883

(22) Filed: Sep. 3, 2014

(30) Foreign Application Priority Data
Jul. 31, 2014 (TW) 103126330

(51) Int. Cl. C09D 5/08; B29C 41/38

(52) U.S. Cl. CPC C09D 5/084; C09D 5/086; B29C 41/38; B29L 2031/757

(57) ABSTRACT

The present invention relates to provide an anticorrosive layer having a biomimetic surface nano microstructure and the application. The anticorrosive layer comprises a polymer and a nano-particle. Both of the nano-particle and the biomimetic surface nano microstructure are required for the anticorrosive layer to effectively enhance the anticorrosive performance.

### BACKGROUND OF THE INVENTION

1. Field of the Invention

The present invention relates to an anticorrosive composition. In particular, the invention relates to an anticorrosive layer having a biomimetic leaf surface nano microstructure and the method of making the same.

2. Description of the Prior Art

Corrosion is natural phenomena and usually caused by oxidation, electro chemical reaction and other factors. Metal always lose their original performance and properties due to corrosion.

So far, steels have been a common industrial material. However, corrosion not only reduces the strength and the shelf life of steels but also results in pollutions.

Hence, it is important to prevent metals from corrosion. In order to evaluate the anticorrosive performance of metals, electrochemical measurements, such as corrosion potential and corrosion current are measured and analyzed for this purpose. In general, when metals have a higher corrosion potential with a lower corrosion current, metals possess a good anticorrosive performance.

It is well known that polymers are applied as an anticorrosive layer for metals. The anticorrosion mechanism is that moisture and oxygen are resisted by the polymers. A main disadvantage of the anticorrosive layer formed by the polymers is that the anticorrosive performance gradually lost due to the age of the polymers.

Another approach for enhancing the anticorrosive performance is to modify surface properties of metals by coating a hydrophobic film on the surface of the metals. When the surface of the metals is hydrophobic or superhydrophobic, the metals often resist corrosion for a period of time. However, Feng et al. taught that a hydrophobic film was decomposed on the exposure of UV light. (J. Am. Chem. Soc 126(1)62˜63) Therefore, the metals having a hydrophobic surface do not effectively solve the corrosion problem.

Other research efforts have focused on adding nanoparticles, such as graphene into polymers to increase the tortuosity of oxygen diffusion pathway. (Polymers for Advanced Technologies (2013), 24(10), 888-894; Surface and Coatings Technology (2013), 232, 475-481). However, corrosion is caused by many factors, decreasing the diffusion rate of oxygen is still not enough for inhibiting corrosion well.

U.S. Pat. No. 5,922,466 disclosed a composite comprising a metal and an anticorrosive layer. The anticorrosive layer is composed of polyaniline. The production cost of polyaniline is high and aniline is toxic and easy to oxidize.

US20110281105A1 disclosed an anticorrosive coating layer comprising a polyelectrolyte and a metal oxide or its salt. The metal oxide or its salt is applied as an anticorrosive reagent, but the compatibility between the metal oxide or its salt and the polymers is not good. As a result, the application of the metal oxide or its salt is limited to use in the polymer-based anticorrosive composition.

### SUMMARY OF THE INVENTION

In light of the above background, in order to fulfill the industrial requirements. One objective of the invention is to provide an anticorrosive composition. The anticorrosive composition comprises a polymer which is selected from one of the group and combinations thereof consisting of poly(methyl methacrylate), polystyrene, polyethylene, polypropylene, polyamide, epoxy resin. Polyimide, polyurethane, polypyrrole, polylactic acid and polycaprolactone; and a nanoparticle which is selected from one of the group and combinations thereof consisting of graphene, vinyl modified silica and amino modified silica. The anticorrosive performance can be controlled by adjusting either the kind of or the weight percent of the polymer and the nanoparticle in the anticorrosive composition.

Another objective of the invention is to provide an anticorrosive layer. The anticorrosive layer comprises a surface having a biomimetic leaf surface nano microstructure, wherein the biomimetic leaf surface nano microstructure is a papillary nano microstructure with an irregular wrinkle appearance. The biomimetic leaf surface nano microstructure can resist the diffusion moisture and oxygen well, so as to enhance the anticorrosive performance of metals with the anticorrosive layer having the biomimetic leaf surface nano microstructure.

Further, the other objective of the invention is to provide a method for inhibiting corrosion on a metal substrate. The method for inhibiting corrosion on a metal substrate comprises providing an imprinting template having a negatively biomimetic leaf surface nano microstructure, wherein the negatively biomimetic leaf nano microstructure is an opposite of the papillary nano microstructure with irregular wrinkle appearance; providing an anticorrosive composition; coating the anticorrosive composition onto the imprinting template to form an anticorrosive layer; covering the anticorrosive layer on a metal substrate; and curing the anticorrosive layer on the metal substrate.

According to the abovementioned objectives of the present invention, it provides an anticorrosive composition which comprises a polymer which is selected from one of the group and combinations thereof consisting of poly(methyl methacrylate), polystyrene, polyethylene, polypropylene, polyamide, epoxy resin. Polyimide, polyurethane, polypyrrole, polylactic acid and polycaprolactone; and a nanoparticle which is selected from one of the group and combinations thereof consisting of graphene, vinyl modified silica and amino modified silica. The anticorrosive performance can be controlled by adjusting either the kind of or the weight percent of the polymer and the nanoparticle in the anticorrosive composition. The weight percent of said polymer is between 90 and 99.9 wt %, and the weight percent of said nanoparticle is between 0.1 and 10 wt %.

The abovementioned anticorrosive composition further comprises a curing agent which is selected from one of the group and combinations thereof consisting of (amine terminated) ether, (α-benzyl-α-(dimethylamino)-4-morpholinobutyro-phenon) and (poly(propylene glycol)bis(2-aminopropyl ether)) and which of the weight percent of said curing agent is between 0.1 and 12 wt %.

According to the abovementioned objectives of the present invention, it provides an anticorrosive layer comprises a surface having a biomimetic leaf surface nano microstructure, wherein the biomimetic leaf surface nano microstructure is a papillary nano microstructure with irregular wrinkle appearance. Furthermore, the anticorrosive layer comprising a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone; and a nanoparticle which is selected from one of the group and combinations thereof consisting of graphene, vinyl modified silica and amino modified silica.

The anticorrosive layer comprises the surface having the biomimetic leaf surface nano microstructure which is xanthosoma sagittifolium leaf surface structure. The characteristics of the biomimetic leaf surface nano microstructure includes the density of the papillary nano microstructure is between 0.0001 and 0.001 μm², the average height of the papillary nano microstructure is between 5 and 12 μm, and the average distance interval of the papillary nano microstructure is between 5 and 50 μm. The corrosion potential of said anticorrosive layer is between −750 mV and −200 mV, and the corrosion current of said anticorrosive layer is between 0.5 μA/cm² and 0.01 μA/cm².

According to the abovementioned objectives of the present invention, it provides a method for inhibiting corrosion on a metal substrate. The method for inhibiting corrosion on a metal substrate comprises providing an imprinting template having a negatively biomimetic leaf surface nano microstructure which is an opposite of papillary nano microstructure with irregular wrinkle appearance; providing an anticorrosive composition comprising a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone, and a nanoparticle which is selected from one of the group and combinations thereof consisting of graphene, vinyl modified silica and amino modified silica; and the weight percent of said polymer is between 90 and 99.9 wt %, and the weight percent of said nanoparticle is between 0.1 and 10 wt %; coating the anticorrosive composition onto the imprinting template having the negatively biomimetic leaf surface nano microstructure to form a coating layer; imprinting the negatively biomimetic leaf nano surface microstructure onto the coating layer to form an anticorrosive layer comprising a surface having a biomimetic leaf surface nano microstructure, wherein the biomimetic leaf nano surface microstructure is a papillary nano microstructure with irregular wrinkle appearance; and curing the anticorrosive layer comprising the surface having the biomimetic leaf surface nano microstructure onto the metal substrate.

The abovementioned imprinting template having the negatively biomimetic leaf surface nano microstructure is produced by the steps comprises providing a clean plant leaf and a substrate; fixing the clean plant leaf onto the substrate; placing the substrate fixed with the clean plant leaf into a mold; pouring an imprinting solution into the mold; performing a curing process; and separating the mold and the clean plant leaf from the substrate to give an imprinting template having the negatively biomimetic leaf surface nano microstructure.

The abovementioned clean plant leaf is xanthosoma sagittifolium leaf.

The abovementioned imprinting solution comprises polydimethylsiloxane and a cross-linking reagent which comprises (poly(dimethyl-methylvinylsiloxane)) and (poly(dimethyl-methylhydrogenosiloxane)).

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A illustrates an anticorrosive layer comprises a surface having a biomimetic leaf surface nano microstructure which is a papillary nano microstructure with irregular wrinkle appearance on a metal substrate;

FIG. 1B shows xanthosoma sagittifolium leaf surface structure;

FIG. 2 shows the process flow diagram for preparing an anticorrosive layer comprises a surface having a biomimetic leaf surface nano microstructure for the second embodiment in accordance with the present invention;

FIG. 3A shows the process flow diagram for preparing an imprinting template having the negatively biomimetic leaf surface nano microstructure for the third embodiment in accordance with the present invention;

FIG. 3B shows the process for preparing an imprinting template having the negatively biomimetic leaf surface nano microstructure;

FIG. 4 shows the process of preparation of the anticorrosive layer having the biomimetic leaf surface nano microstructure formed by epoxy resin and graphene for example 2 in accordance with the present invention;

FIG. 5 shows the process of preparation of the anticorrosive layer having the biomimetic leaf surface nano microstructure formed by poly(methyl methacrylate) and graphene for example 3 in accordance with the present invention;

FIG. 6 shows the process of preparation of the anticorrosive layer having the biomimetic leaf surface nano microstructure formed by poly(methyl methacrylate) and vinyl modified silica for example 4 in accordance with the present invention;

FIG. 7 shows the process of preparation of the anticorrosive layer having the biomimetic leaf surface nano microstructure formed by epoxy resin and amino modified silica for example 5 in accordance with the present invention;

FIG. 8A shows the SEM photo of the anticorrosive layer having the biomimetic leaf surface nano microstructure formed by epoxy resin and graphene for example 2 in accordance with the present invention;

FIG. 8B shows the SEM photo of the anticorrosive layer having the biomimetic leaf surface nano microstructure formed by poly(methyl methacrylate) and graphene for example 3 in accordance with the present invention; and

FIG. 8C shows the SEM photo of the anticorrosive layer having the biomimetic leaf surface nano microstructure formed by poly(methyl methacrylate) and vinyl modified silica for example 4 in accordance with the present invention.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

In the first embodiment, the invention is to provide an anticorrosive composition, wherein the anticorrosive composition comprises a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone, and a nanoparticle which is selected from one of the group and combinations thereof consisting of graphene, vinyl modified silica and amino modified silica. The weight percent of said polymer is between 90 and 99.9 wt %, and the weight percent of said nanoparticle is between 0.1 and 10 wt %. The anticorrosive performance can be controlled by adjusting either the kind of or the weight percent of the polymer and the nanoparticle in the anticorrosive composition.

In one example of this embodiment, the anticorrosive composition consists of 98.6 wt % of epoxy resin and 1.4 wt % of graphene.

In one example of this embodiment, the anticorrosive composition consists of 99.5 wt % of poly(methyl methacrylate) and 0.5 wt % of graphene.

In one example of this embodiment, the anticorrosive composition consists of 95 wt % of poly(methyl methacrylate) and 5 wt % of vinyl modified silica.

In another example of this embodiment, the anticorrosive composition consists of 98.8 wt % of epoxy resin and 1.2 wt % of amino modified silica.

The anticorrosive composition further comprises a curing agent which of the weight percent is between 0.1 and 12 wt %.

In one example of this embodiment, the curing agent is selected from one of the group and combinations thereof consisting of (amine terminated) ether, (α-benzyl-α-(dimethylamino)-4-morpholinobutyro-phenon) and (poly(propylene glycol)bis(2-aminopropyl ether)).

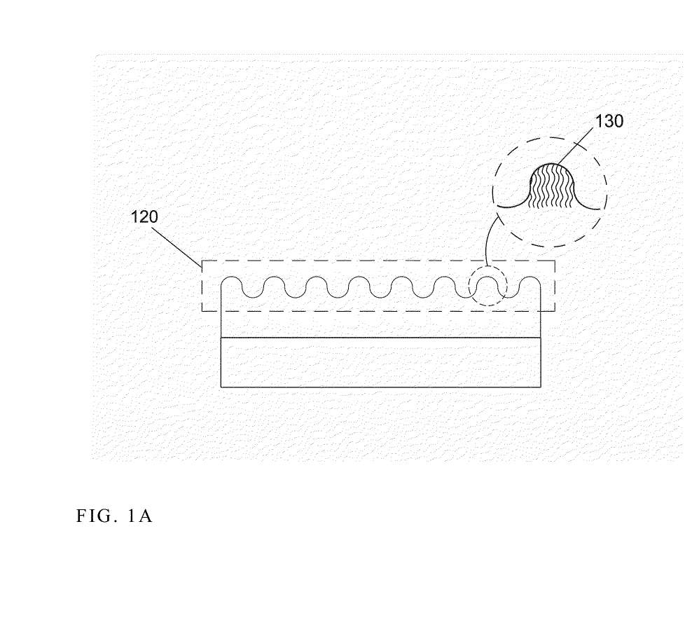

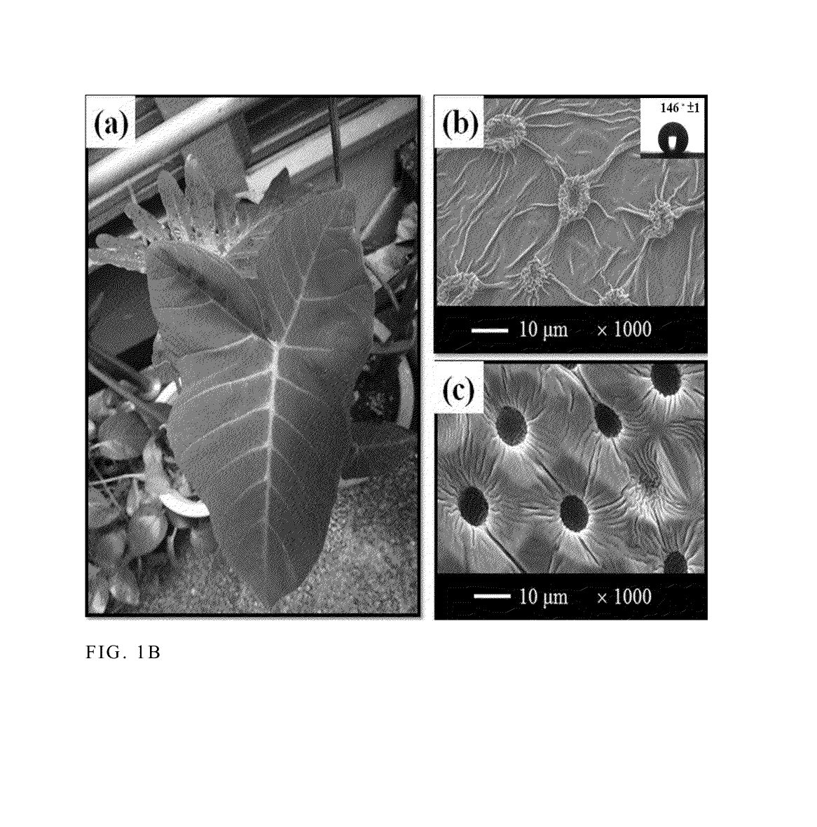

Referring to FIG. 1A, according to the second embodiment of the present invention, the present invention provides an anticorrosive layer 100 comprises a surface having a biomimetic leaf surface nano microstructure 120 on a metal substrate 110 formed by the anticorrosive composition as described in the first embodiment in the invention. The abovementioned metal substrate 110 comprises carbon steel, cold rolled steel and hot rolled steel. Moreover, the anticorrosive layer 100 comprises the surface having the biomimetic leaf surface nano microstructure 120 is a papillary nano microstructure with irregular wrinkle appearance 130. The biomimetic leaf surface nano microstructure 120 is replicated from xanthosoma sagittifolium leaf surface structure which referring to (a) and (b) in FIG. 1B. The abovementioned anticorrosive layer 100 further is fixed onto the metal substrate 110 to form an anticorrosive surface having the biomimetic leaf surface nano microstructure 120, wherein the anticorrosive surface having the biomimetic leaf surface nano microstructure 120 possesses the corrosion potential being between −750 mV and −200 mV, and the corrosion current being between 0.5 μA/cm² and 0.01 μA/cm².

The composition of the anticorrosive layer 100 comprises the surface having the biomimetic leaf surface nano microstructure 120 is selected from the one of the group and combinations thereof consisting of epoxy resin and graphene, poly(methyl methacrylate) and graphene, poly(methyl methacrylate) and vinyl modified silica, epoxy resin and amino modified silica. Additionally, the anticorrosive layer 100 comprises the surface having the biomimetic leaf surface nano microstructure 120 formed by the abovementioned composition possesses the corrosion potential being more than −500 mV, and the corrosion current being less than 0.4 μA/cm².

In one preferred example of the second embodiment, the anticorrosive layer 100 comprises the surface having the biomimetic leaf surface nano microstructure 120 formed by the composition consisting of 95 weight percent of poly(methyl methacrylate) and 5 weight percent of vinyl modified silica possesses the corrosion potential being −320 mV, and the corrosion current being 0.03 μA/cm².

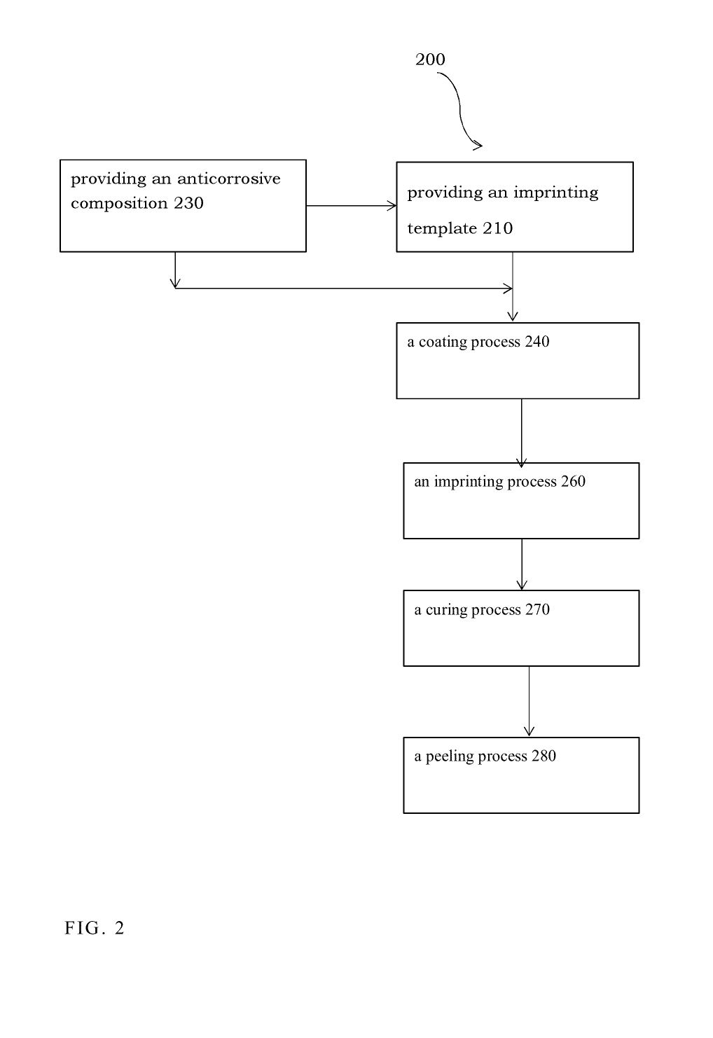

Referring to FIG. 2, according to the third embodiment of the present invention, the present invention provides a method 200 for inhibiting corrosion on a metal substrate 110. The method 200 for inhibiting corrosion on a metal substrate 110 comprises the steps of providing an imprinting template 210 having a negatively biomimetic leaf surface nano microstructure 220 which is an opposite of papillary nano microstructure 225 with irregular wrinkle appearance 225a, providing an anticorrosive composition 230 comprising a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone, and a nanoparticle which is selected from one of the group and combinations thereof consisting of graphene, vinyl modified silica and amino modified silica. Furthermore, the weight percent of said polymer is between 90 and 99.9 wt %, and the weight percent of said nanoparticle is between 0.1 and 10 wt %, performing a coating process 240 to have the anticorrosive composition 230 onto the imprinting template 210 having the negatively biomimetic leaf surface nano microstructure 220 to form a coating layer 250, performing an imprinting process 260 to have the negatively biomimetic leaf nano surface microstructure 220 onto the coating layer 250 to form the anticorrosive layer 100 comprising the surface having the biomimetic leaf surface nano microstructure 120 which is a papillary nano microstructure with irregular wrinkle appearance 130; and performing a curing process 270 to have the anticorrosive layer 100 comprising the surface having the biomimetic leaf surface nano microstructure 120 onto the metal substrate 205. The abovementioned curing process 270 further comprises a heat curing method and a light curing method. Additionally, the third embodiment further comprises a peeling process 280 to remove the imprinting template 210 after the curing process 270.

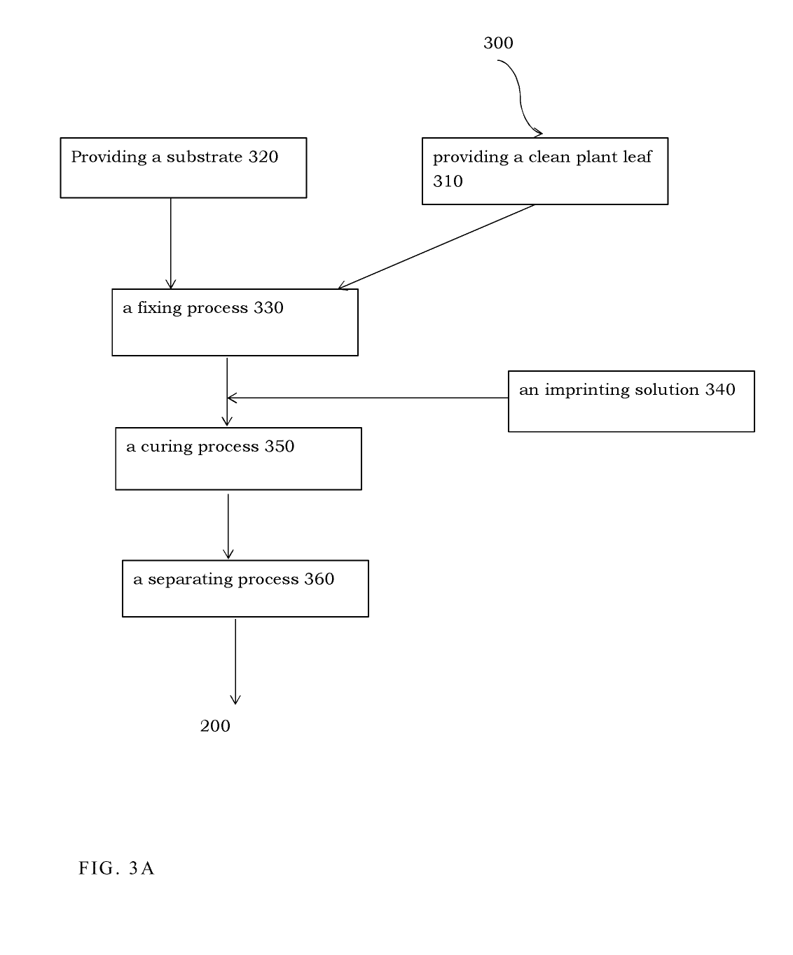

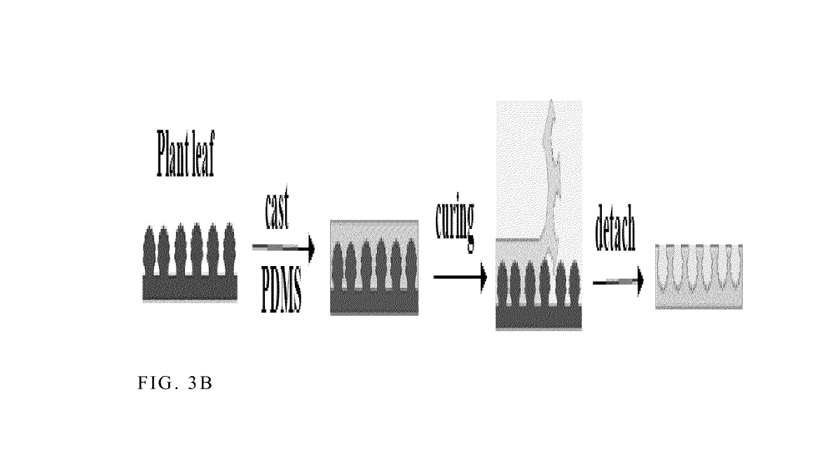

Referring to FIG. 3A, according to the third embodiment of the present invention, the present invention provides a method 300 for producing the imprinting template 210 having the negatively biomimetic leaf surface nano microstructure 220. The method 300 comprises the steps of providing a clean plant leaf 310 which is xanthosoma sagittifolium leaf and a substrate 320 which comprises a glass; performing a fixing process 330 to have the clean plant leaf 310 onto the substrate 320; placing the substrate 320 fixed with the clean plant leaf 310 into a mold; pouring an imprinting solution 340 which comprises poly(dimethyl-methylvinylsiloxane) and (poly(dimethyl-methylvinylsiloxane)) into the mold; performing a curing process 350 to have the imprinting solution 340 solidification at temperature between 50 and 60° C.; and performing a separating process 360 to peel the mold and the clean plant leaf 310 from the substrate 320 to give the imprinting template 210 having the negatively biomimetic leaf surface nano microstructure 220 which referring to (c) in FIG. 1B.

The abovementioned imprinting template 210 having the negatively biomimetic leaf surface nano microstructure 220 is able to exactly replicate the biomimetic leaf surface nano microstructure 120 to the anticorrosive layer 100 coating on the metal substrate. Accordingly, the biomimetic leaf surface nano microstructure 120 is the same as the appearance of the clean plant leaf 310.

In one example of the third embodiment, the abovementioned clean plant leaf 310 is xanthosoma sagittifolium leaf. So as to the anticorrosive layer 100 having the biomimetic leaf surface nano microstructure 120 possesses the characteristic as follows: the density of the papillary nano microstructure is between 0.0001 and 0.001 μm², the average height of the papillary nano microstructure is between 5 and 12 μm, and the average distance interval of the papillary nano microstructure is between 5 and 50 μm. Preferably, the density of the papillary nano microstructure is between 0.0005 and 0.0006 μm², the average height of the papillary nano microstructure is between 7 and 9 μm, and the average distance interval of the papillary nano microstructure is between 8 and 30 μm. In addition, the corrosion potential of said anticorrosive layer 100 is between −750 mV and −200 mV, and the corrosion current of said anticorrosive layer 100 is between 0.5 μA/cm² and 0.01 μA/cm².

In accordance with the foregoing summary, the following presents a detailed description of the example of the present invention, which is presently considered the best mode thereof. However, this invention can also be applied extensively to other embodiments, and the scope of this present invention is expressly not limited except as specified in the accompanying claims.

### Example 1

### Preparation of the Imprinting Template Having the Negatively Biomimetic Leaf Surface Nano Microstructure Referred to FIG. 3B

The polydimethylsiloxane (PDMS) prepolymer was obtained by mixing the elastomer base and curing agents which are (poly(dimethyl methylhydrogenosiloxane) and (poly(dimethyl-methylvinylsiloxane)) in a proper ratio (10:1, w/w). The PDMS pre-polymer was poured into 3·6 cm2 molds fixed to a piece of fresh, natural Xanthosoma sagittifolium leaf (The veins of the leaf were removed in an area of about 3·6 cm2.) and then cured in a 40° C. oven for 4 h. After curing, the PDMS blocks were separated from the molds and used as the imprinting template having the negatively biomimetic leaf surface nano microstructure.

### Example 2

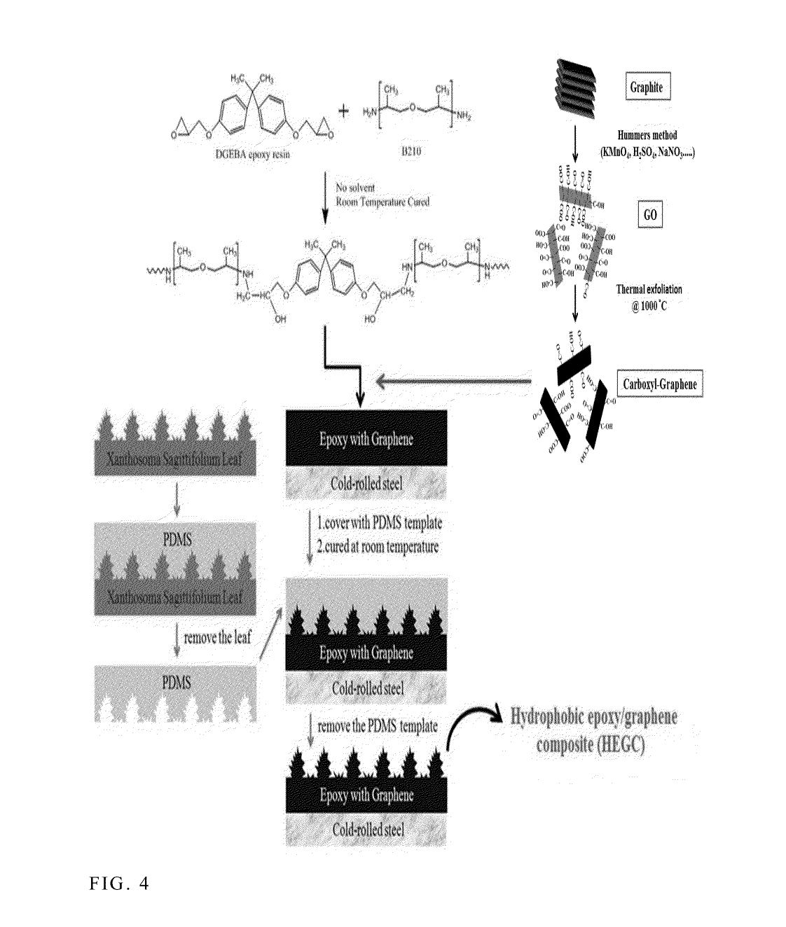

### Preparation of the Anticorrosive Layer Having the Biomimetic Leaf Surface Nano Microstructure Formed by Epoxy Resin and Graphene Referred to FIG. 4

Preparation of the Graphene by Hummers Method

8 g of graphite and 4 g of NaNO₃ were added to 560 ml of H₂SO₄ to form a mixture; 24 g of KMnO₄ was slowly added to the above mixture and stirred for 2 hours below 10° C. The mixture was diluted with 800 ml of de-ionized water, and then 5% H2O2 was added into the solution until the color of the mixture changed to brown to ensure that KMnO4 was fully reduced. The as-prepared graphene oxide slurry was re-dispersed in de-ionized water. Then, the mixture was washed with 0.1 M HCl solution to remove SO₄²⁻ ions. Subsequently, the graphene oxide solution was washed with distilled water to remove the residual acid until the solution pH was ca. 5 and then vacuum dried at 50 C. The graphene oxide powder was put into the furnace at 1000 C for 30 s for thermal exfoliation. Finally, the graphene was obtained as ready for using in example 2 and example 3.

In a typical coatings synthesis procedure, 0.5 g of ((poly(propylene glycol)bis(2-aminopropyl ether), 1.5 g of DGEBA and 0.02 g of graphene were mixed at room temperature using a three-roll mill. After mixing, the mixture was coated on the cold-rolled steel. The imprinting template prepared from the example 1 was subsequently pressed against the coating. The sample was cured at room temperature and then the coating layer having a xanthosoma sagittifolium leaf structure was obtained after peeling off the imprinting template. The coating layer is the anticorrosive layer having the biomimetic leaf surface nano microstructure formed by epoxy resin and graphene. The biomimetic leaf surface nano microstructure is xanthosoma sagittifolium leaf surface structure.

### Example 3

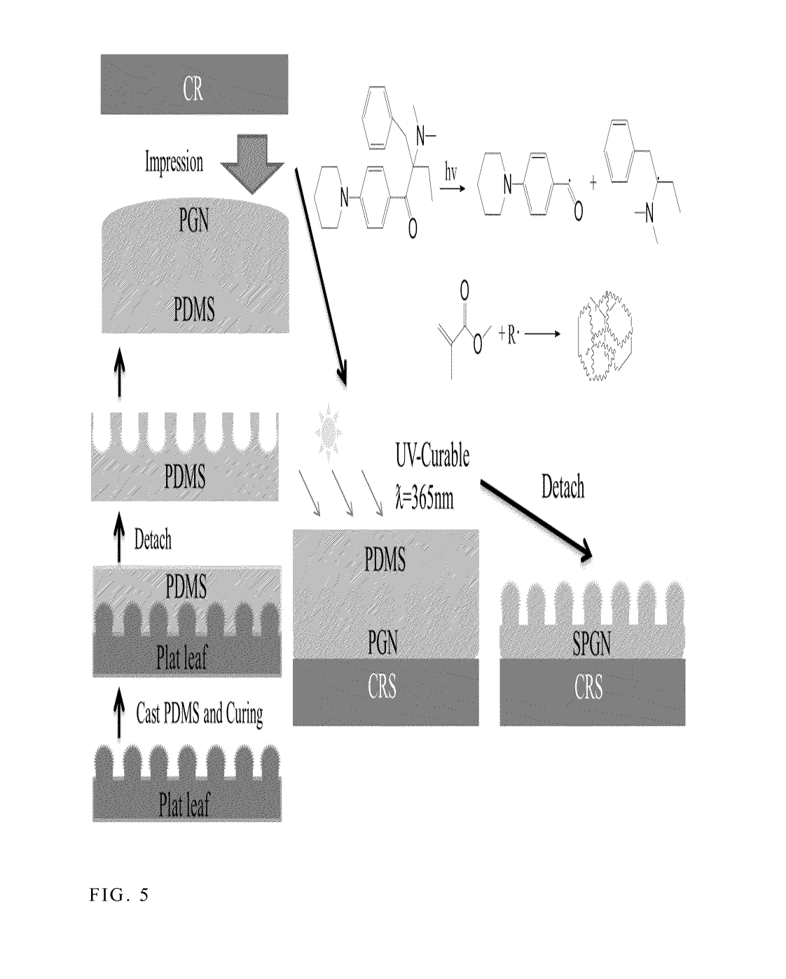

### Preparation of the Anticorrosive Layer Having the Biomimetic Leaf Surface Nano Microstructure Formed by Poly(Methyl Methacrylate) and Graphene Referred to FIG. 5

In a typical coatings synthesis procedure, 0.01 g of photo initiator (α-benzyl-α-(dimethylamino)-4-morpholinobutyro-phenon), 10 g of methyl methacrylate monomer and 0.05 g of graphene were mixed at room temperature using a three-roll mill. After mixing, the mixture was coated on the cold-rolled steel. The imprinting template prepared from the example 1 was subsequently pressed against the coating. The sample was cured on the exposure of UV light (365 nm) and then the coating layer having a xanthosoma sagittifolium leaf structure was obtained after peeling off the imprinting template. The coating layer is the anticorrosive layer having the biomimetic leaf surface nano microstructure formed by poly(methyl methacrylate) and graphene. The biomimetic leaf surface nano microstructure is xanthosoma sagittifolium leaf surface structure.

### Example 4

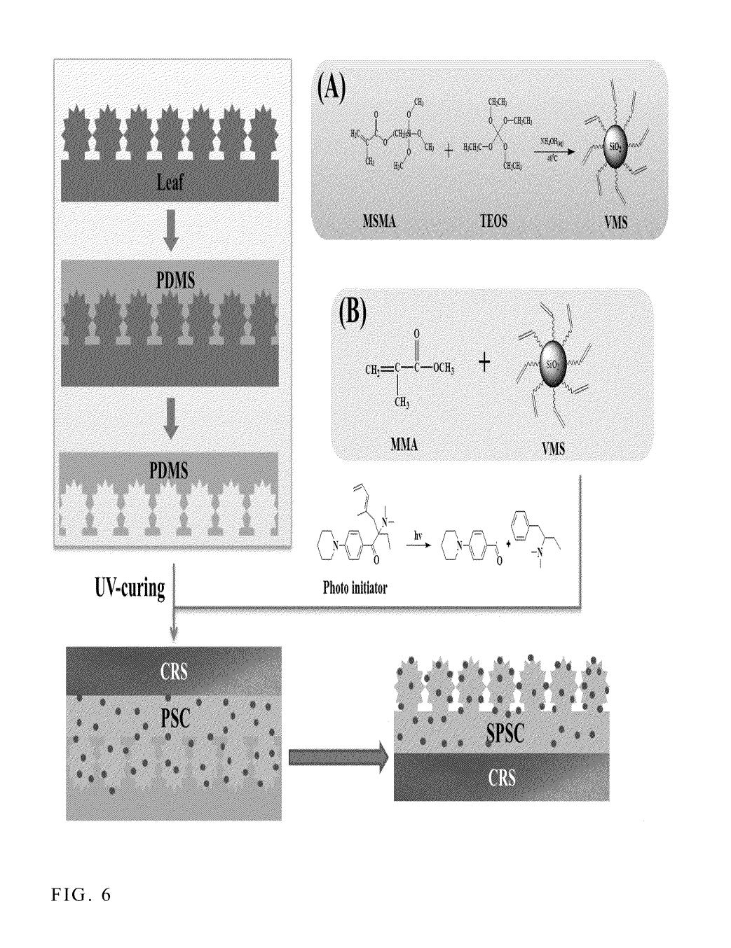

### Preparation of the Anticorrosive Layer Having the Biomimetic Leaf Surface Nano Microstructure Formed by Poly(Methyl Methacrylate) and Vinyl Modified Silica Referred to FIG. 6

2.48 g of 3-(Methacryloxy)propylrimethoxysilan (MSMA) and 0.52 g of Tetraethyl orthosilicate (TEOS) were mixed ° To 50 ml ammonia aqueous solution (pH=9) was added the mixture of MSMA and TEOS, and then stirred at 40° C. for 12 hours. Isolated the product by centrifuge and filtration and washed the product with alcohol. The product was dried under vacuum for 12 hours and milled. The product is vinyl modified silica as ready for using in the following synthesis procedure.

In a typical coatings synthesis procedure, 0.01 g of photo initiator (α-benzyl-α-(dimethylamino)-4-morpholinobutyro-phenon), 9.5 g of methyl methacrylate monomer and 0.5 g of vinyl modified silica were mixed at room temperature using a three-roll mill. After mixing, the mixture was coated on the cold-rolled steel. The imprinting template prepared from the example 1 was subsequently pressed against the coating. The sample was cured on the exposure of UV light (365 nm) and then the coating layer having a xanthosoma sagittifolium leaf structure was obtained after peeling off the imprinting template. The coating layer is the anticorrosive layer having the biomimetic leaf surface nano microstructure formed by poly(methyl methacrylate) and vinyl modified silica. The biomimetic leaf surface nano microstructure is xanthosoma sagittifolium leaf surface structure.

### Example 5

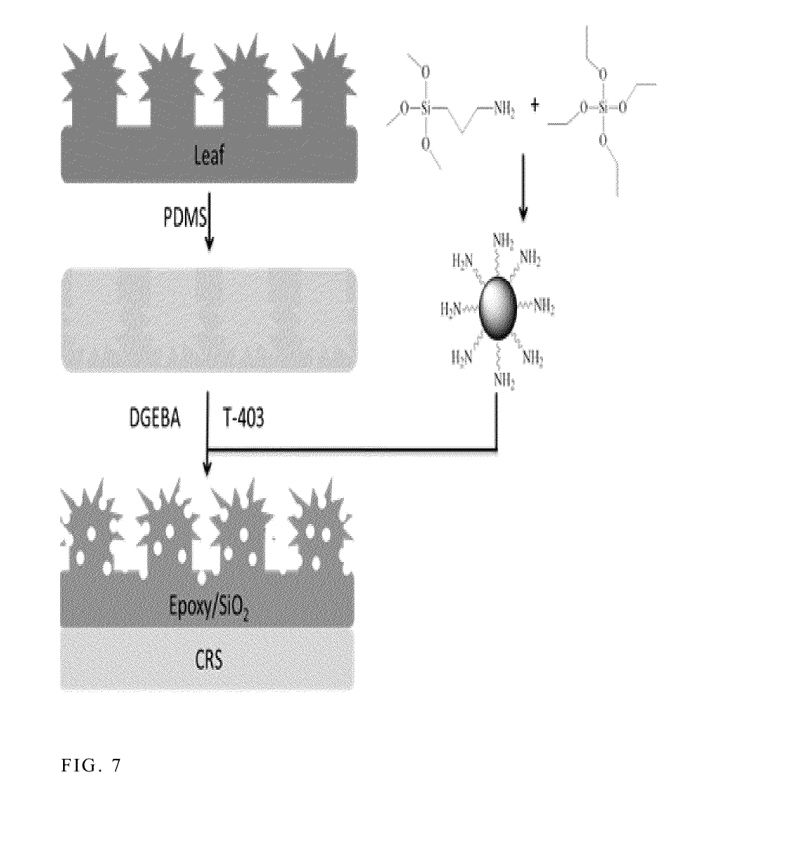

### Preparation of the Anticorrosive Layer Having the Biomimetic Leaf Surface Nano Microstructure Formed by Epoxy Resin and Amino Modified Silica Referred to FIG. 7

2.04 g of Trimethoxy(methyl) silane and 0.136 g of (3-Aminopropyl)trimethoxysilanewere mixed. To 50 ml ammonia aqueous solution (pH=9) was added the mixture of trimethoxy(methyl) silane and (3-Aminopropyl)trimethoxysilanewere, and then stirred at 40° C. for 12 hours. Isolated the product by centrifuge and filtration and washed the product with alcohol. The product was dried under vacuum for 12 hours and milled. The product is amino modified silica as ready for using in the following synthesis procedure.

In a typical coatings synthesis procedure, 1.024 g of DGEBA and 0.075 g of amino modified silica were stirred for 1 hour first and then followed by adding 5 g of DGEBA and 0.5 g of amine terminated ether as the curing agent. The above mixture was mixed at room temperature using a three-roll mill. After mixing, the mixture was coated on the cold-rolled steel. The imprinting template prepared from the example 1 was subsequently pressed against the coating. The sample was cured at room temperature and then the coating layer having a xanthosoma sagittifolium leaf structure was obtained after peeling off the imprinting template. The coating layer is the anticorrosive layer having the biomimetic leaf surface nano microstructure formed by epoxy resin and graphene. The biomimetic leaf surface nano microstructure is xanthosoma sagittifolium leaf surface structure.

The composition of the abovementioned anticorrosive layer prepared in example 2˜5 is shown in TABLE I

TABLE I

| Ex. | Polymer (weight %) | Nanoparticle (weight %) |
|---|---|---|
| 2 | Epoxy resin (98.6%) | Graphene (1.4%) |
| 3 | Poly(methyl methacrylate) (99.5%) | Graphene (0.5%) |
| 4 | Poly(methyl methacrylate) (95%) | Vinyl modified silica (5%) |
| 5 | Epoxy resin (98.8%) | Amino modified silica (1.2%) |

Ex. = Example

The xanthosoma sagittifolium leaf surface structure and the surface nano microstructure of the anticorrosive layer formed by the procedure described in example 2, 3 and 4 were observed by scanning electron microscopy (SEM) and analyzed their water contact angle for evaluating the hydrophobic property. Additionally, both of the corrosion potential and the corrosion current were also measured for evaluating the anticorrosive performance.

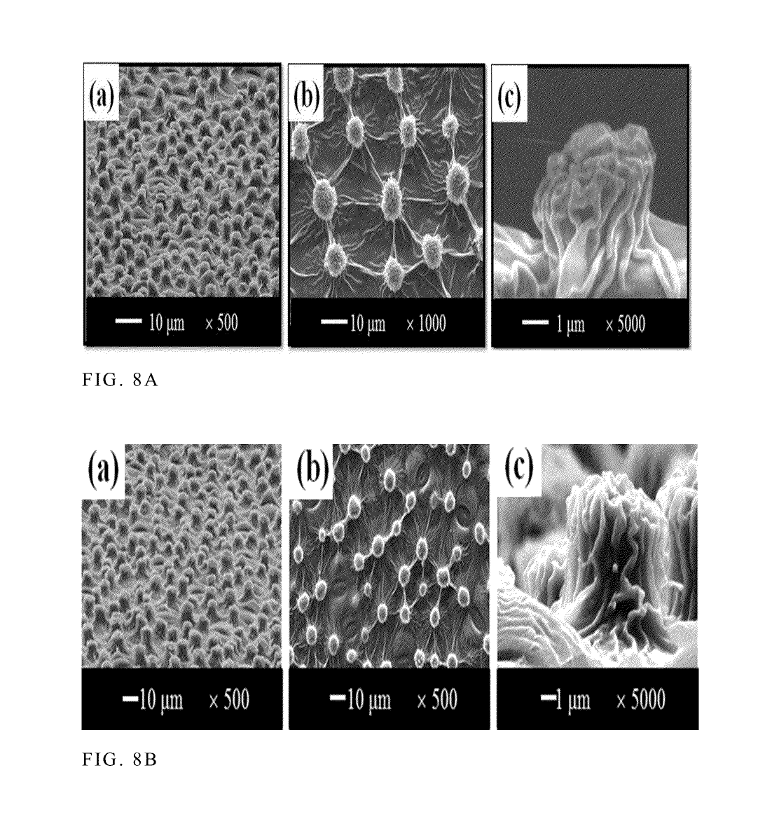

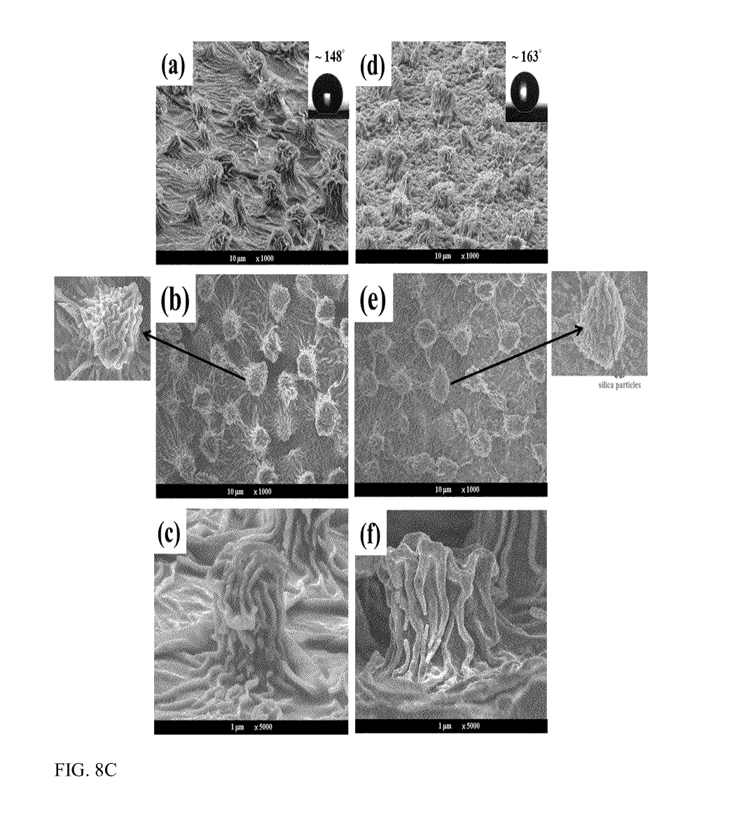

The SEM photo which referring to FIG. 4 showed the xanthosoma sagittifolium leaf surface structure is a papillary nano microstructure with irregular wrinkle appearance. Compared to the abovementioned xanthosoma sagittifolium leaf surface structure, the SEM photos which referring to FIG. 8A, FIG. 8B and FIG. 8C were the surface nano microstructure of the anticorrosive layer formed by the procedure described in example 2, 3 and 4. According to the SEM photos, it showed xanthosoma sagittifolium leaf surface structure is exactly replicated onto the surface of the anticorrosive layer. The abovementioned anticorrosive layer possesses the biomimetic leaf surface nano microstructure which is the papillary nano microstructure with irregular wrinkle appearance.

The evaluation of the anticorrosive performance and the hydrophobic property of the anticorrosive layers.

The anticorrosive performance is study by measurement of the corrosion potential and the corrosion current of the anticorrosive layer. The anticorrosive layer with a higher corrosion potential, but a lower corrosion current simultaneously means that it possesses excellent anticorrosive performance. The hydrophobic property is evaluated by measurement of water contact angle. The anticorrosive layer with the larger water contact angle show more hydrophobic.

The electrochemical corrosion measurement was performed using a VoltaLab 50. All the electrochemical corrosion measurements were performed in a double-wall jacketed cell, covered with a glass plate, using which water was maintained at a constant operational temperature of 25±0.5 C. Open-circuit potential (OCP) at the equilibrium state of the system was recorded as the corrosion potential (E_{corr} in mV versus saturated calomel electrode (SCE)). Tafel plots were obtained by scanning the potential from −500 to 500 mV above E_{corr} at a scan rate of 10 mV min⁻¹. The corrosion current (I_{corr}) was determined by superimposing a straight line along the linear portion of the cathodic or anodic curve and extrapolating it through E_{corr}.

The corrosion potential, corrosion current and water contact angle of the control groups and anticorrosive layer prepared in example 2˜5 were shown in TABLE II

TABLE II

| | | Corrosion | Corrosion | Water contact |
|---|---|---|---|---|
| Anticorrosive layer/ | XSLS | Potential | Current | angle |
| substrate | structure | (mV) | (μA/cm²) | degree |
| CRS | No | −800 | 73.4 | — |
| Epoxy resin/CRS | No | −678 | 1.07 | 82 |
| Epoxy resin/CRS | Yes | −633 | 0.35 | 126 |
| Example 2 | Yes | −441 | 0.10 | 128 |
| Example 3 | Yes | −344 | 0.37 | 150 |
| PMMA/CRS | No | −647 | 10.15 | 80 |
| PMMA/CRS | Yes | −501 | 0.75 | 148 |
| Example 4 | Yes | −320 | 0.03 | 163 |
| Example 5 | Yes | −480 | 0.17 | 145 |

CRS: Cold rolled steel
PMMA: Poly(methyl methacrylate)
XSLS structure: Xanthosoma sagittifolium leaf surface structure

According to TABLE II, the cold rolled steel without coating any anticorrosive layer which has the corrosion potential of −880 mV and the corrosion current of 73.4 μA/cm² represents very poor anticorrosive performance. The anticorrosive layers formed only by epoxy resin, poly(methyl methacrylate), epoxy resin without adding the nanoparticle or poly(methyl methacrylate) without adding the nanoparticle were used as the control groups in the experiment. All of them have the corrosion potential less than −500 mV and the corrosion current higher than 0.5 μA/cm². In contrast, the anticorrosive layers prepared by the procedure described in example 2, 3, 4 and 5 have the corrosion potential higher than −500 mV and the corrosion current less than 0.4 μA/cm². In other words, this means they possess good anticorrosive performance. Moreover, the anticorrosive layer having the biomimetic leaf surface nano microstructure described in Example 4 has the corrosion potential of −320 mV and the corrosion current of 0.03 μA/cm² show the most excellent anticorrosive performance.

In order to understand the relationship between anticorrosive performance and surface hydrophobic properties in more detail, one anticorrosive layer having the biomimetic leaf surface nano microstructure but only consisting of poly(methyl methacrylate) has the corrosion potential of −501 mV and the corrosion current of 0.75 μA/cm². However, the anticorrosive layer having the biomimetic leaf surface nano microstructure and consisting of not only poly(methyl methacrylate) but also vinyl modified silica as described in Example 4 has the corrosion potential of −320 mV and the corrosion current of 0.03 μA/cm² represents the most excellent anticorrosive performance. In other word, the surface hydrophobic property is not the only key for enhancing anticorrosive performance. Therefore, it is necessary for the anticorrosive layer to have excellent anticorrosive performance by synergistic effect resulted from many factors.

To sum up, the present invention provides an anticorrosive composition which comprises a polymer and a nanoparticle, an anticorrosive layer which comprises a surface having a biomimetic leaf surface nano microstructure consists of the abovementioned anticorrosive composition and a method for inhibiting corrosion on a metal substrate. by forming the anticorrosive layer which comprises the surface having the biomimetic leaf surface nano microstructure. According to the present invention, the anticorrosive performance of the metal substrate is able to be effectively enhanced and the corrosion problem is well solved in the industries.

Although specific embodiments have been illustrated and described, it will be obvious to those skilled in the art that various modifications may be made without departing from what is intended to be limited solely by the appended claims.

What is claimed is:

1. An anticorrosive composition, said anticorrosive composition comprising:
a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone; and
a nanoparticle which is selected from one of the group and combinations thereof consisting of graphene, vinyl modified silica and amino modified silica.

2. The anticorrosive composition of claim 1, wherein the weight percent of said polymer is between 90 and 99.9 wt %, and the weight percent of said nanoparticle is between 0.1 and 10 wt %.

3. The anticorrosive composition of claim 2, wherein the weight percent of said polymer is 98.6 wt % of epoxy resin and the weight percent of said nanoparticle is 1.4 wt % of graphene.

4. The anticorrosive composition of claim 2, wherein the weight percent of said polymer is 99.5 wt % of poly(methyl methacrylate) and the weight percent of said nanoparticle is 0.5 wt % of graphene.

5. The anticorrosive composition of claim 2, wherein the weight percent of said polymer is 95 wt % of poly(methyl methacrylate) and the weight percent of said nanoparticle is 5 wt % of vinyl modified silica.

6. The anticorrosive composition of claim 2, wherein the weight percent of said polymer is 98.8 wt % of epoxy resin and the weight percent of said nanoparticle is 1.2 wt % of amino modified silica.

7. The anticorrosive composition of claim 1, further comprises a curing agent being between 0.1 and 12 wt %.

8. The anticorrosive composition of claim 7, wherein the curing agent is selected from one of the group and combinations thereof consisting of (amine terminated) ether, (α-benzyl-α-(dimethylamino)-4-morpholinobutyro-phenon) and (poly(propylene glycol)bis(2-aminopropyl ether)).

9. An anticorrosive layer, said anticorrosive layer comprising:
a surface having a biomimetic leaf surface nano microstructure which is a papillary nano microstructure with irregular wrinkle appearance; and
formed by a composition comprising a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone; and
a nanoparticle which is selected from one of the group and combinations thereof consisting of graphene, vinyl modified silica and amino modified silica.

10. The anticorrosive layer of claim 9, wherein the biomimetic leaf nano microstructure is xanthosoma sagittifolium leaf surface structure.

11. The anticorrosive layer of claim 9, wherein the corrosion potential of said anticorrosive layer is between −750 mV and −200 mV, and the corrosion current of said anticorrosive layer is between 0.5 μA/cm² and 0.01 μA/cm².

12. The anticorrosive layer of claim 9, wherein the composition of said anticorrosive layer is selected from the group consisting of following: epoxy resin and graphene, poly(methyl methacrylate) and graphene, poly(methyl methacrylate) and vinyl modified silica, epoxy resin and amino modified silica.

13. The anticorrosive layer of claim 12, wherein the composition of said anticorrosive layer consists of 95 weight percent of poly(methyl methacrylate) and 5 weight percent of vinyl modified silica.

14. The anticorrosive layer of claim 13, wherein the corrosion potential of said anticorrosive layer consisting of 95 weight percent of poly(methyl methacrylate) and 5 weight percent of vinyl modified silica is −320 mV, and the corrosion current of said anticorrosive layer consisting of 95 weight percent of poly(methyl methacrylate) and 5 weight percent of vinyl modified silica is 0.03 μA/cm².

15. The anticorrosive layer of claim 9, wherein the density of the papillary nano microstructure is between 0.0001 and 0.001 μm², the average height of the papillary nano microstructure is between 5 and 12 μm, and the average distance interval of the papillary nano microstructure is between 5 and 50 μm.

16. The anticorrosive layer of claim 15, wherein the density of the papillary nano microstructure is between 0.0005 and 0.0006 μm², the average height of the papillary nano microstructure is between 7 and 9 μm, and the average distance interval of the papillary nano microstructure is between 8 and 30 μm.

17. A method for inhibiting corrosion on a metal substrate, said method for inhibiting corrosion on a metal substrate comprising:
providing an imprinting template having a negatively biomimetic leaf surface nano microstructure, wherein the negatively biomimetic leaf surface nano microstructure is an opposite of a papillary nano microstructure with irregular wrinkle appearance;
providing an anticorrosive composition comprising a polymer which is selected from one of the group and combinations thereof consisting of poly(methyl methacrylate), polystyrene, polyethylene, polypropylene, polyamide, epoxy resin, polyimide, polyurethane, polypyrrole, polylactic acid and polycaprolactone, and a nanoparticle which is selected from one of the group and combinations thereof consisting of graphene, vinyl modified silica and amino modified silica; and the weight percent of said polymer is between 90 and 99.9 wt %, and the weight percent of said nanoparticle is between 0.1 and 10 wt %;
coating the anticorrosive composition onto the imprinting template having the negatively biomimetic leaf surface nano microstructure to form a coating layer;
imprinting the negatively biomimetic leaf surface nano microstructure onto the coating layer to form an anticorrosive layer comprising a surface having a biomimetic leaf surface nano microstructure, wherein the biomimetic leaf surface nano microstructure is the papillary nano microstructure with irregular wrinkle appearance; and
curing the anticorrosive layer comprising the surface having the biomimetic leaf surface nano microstructure onto the metal substrate.

18. The method for inhibiting corrosion on a metal substrate of claim 17, wherein the method for producing the imprinting template having a negatively biomimetic leaf surface nano microstructure comprising:
providing a clean plant leaf and a substrate;
fixing the clean plant leaf onto the substrate;
placing the substrate fixed with the clean plant leaf into a mold;
pouring an imprinting solution into the mold;
performing a curing process; and
separating the mold and the clean plant leaf from the substrate to give an imprinting template, having the negatively biomimetic leaf surface nano microstructure.

19. The method for inhibiting corrosion on a metal substrate of claim 18, wherein the imprinting solution comprises a polydimethylsiloxane and a crosslinking reagent, and where said crosslinking reagent comprises (poly(dimethyl-methylvinylsiloxane)) and (poly(dimethyl-methylhydrogenosiloxane)).

20. The method for inhibiting corrosion on a metal substrate of claim 17, wherein the biomimetic leaf surface nano microstructure is xanthosoma sagittifolium leaf surface structure.

21. The method for inhibiting corrosion on a metal substrate of claim 17, wherein the density of the papillary nano microstructure is between 0.0001 and 0.001 μm², the average height of the papillary nano microstructure is between 5 and 12 μm, and the average distance interval of the papillary nano microstructure is between 5 and 50 μm.

22. The method for inhibiting corrosion on a metal substrate of claim 17, wherein the density of the papillary nano microstructure is between 0.0005 and 0.0006 μm², the average height of the papillary nano microstructure is between 7 and 9 μm, and the average distance interval of the papillary nano microstructure is between 8 and 30 μm.

23. The method for inhibiting corrosion on a metal substrate of claim 17, wherein the anticorrosive composition consists of 95 weight percent of poly(methyl methacrylate) and 5 weight percent of vinyl modified silica.

24. The method for inhibiting corrosion on a metal substrate of claim 17, wherein the anticorrosive composition consists of 98.6 weight percent of epoxy resin and 1.4 weight percent of graphene.

25. The method for inhibiting corrosion on a metal substrate of claim 17, wherein the anticorrosive composition consists of 99.5 weight percent of poly(methyl methacrylate) and 0.5 weight percent of graphene.

26. The method for inhibiting corrosion on a metal substrate of claim 17, wherein the anticorrosive composition consists of 98.8 weight percent of epoxy resin and 1.2 weight percent of amino modified silica.

27. The method for inhibiting corrosion on a metal substrate of claim 17, wherein the anticorrosive composition further comprising a curing agent which is selected from one of the group and combinations thereof consisting of (amine terminated) ether, (α-benzyl-α-(dimethylamino)-4-morpholinobutyro-phenon) and (poly(propylene glycol)bis(2-aminopropyl ether)).

28. The method for inhibiting corrosion on metals of claim 27, wherein the weight percent of said curing agent is between 0.1 and 12 wt %.
